(19) United States
(12) Patent Application Publication
(10) Pub. No.: US 2010/0285990 A1
(43) Pub. Date: Nov. 11, 2010

(54) NEURITE OUTGROWTH AS AN ASSAY FOR MEMORY ENHANCING COMPOUNDS

(76) Inventors: Timothy P. Tully, Solana Beach, CA (US); Marco Peters, La Jolla, CA (US); Roderick E. Scott, Poway, CA (US)

Correspondence Address: DON J. PELTO;Sheppard, Mullin, Richter & Hampton LLP, 1300 I STREET, NW, 11TH FLOOR EAST, WASHINGTON, DC, 20005, US

(21) Appl. No.: 12/810,617

(22) PCT Filed: Dec. 29, 2008
(86) PCT No.: PCT/US08/88477

§ 371 Date: Jun. 25, 2010

Related U.S. Application Data
(60) Provisional application No. 61/017,134, filed on Dec. 27, 2007.

(51) Int. Cl. C40B 30/06; C40B 30/00

(52) U.S. Cl. 506/10; 506/7

(57) ABSTRACT

The disclosed invention relates to cell based screening assays that are useful to identify compounds that enhance memory in normal and memory impaired individuals.

### RELATED APPLICATION

This application claims the benefit of priority of U.S. Provisional Application No. 61/017,134, filed Dec. 27, 2007, which is hereby incorporated by reference in its entirety.

### SEQUENCE LISTING

The instant application contains a Sequence Listing which has been submitted via EFS-Web and is hereby incorporated by reference in its entirety. Said ASCII copy, created on Jun. 24, 2010, is named 21RE1466.txt, and is 1,295 bytes in size.

### TECHNICAL FIELD

The presently disclosed invention relates to the use of neurite outgrowth assays as a screen for compounds that enhance and improve memory function.

### BACKGROUND ART

A growing body of evidence suggests that neurons continue to proliferate in the adult brain (Arsenijevic, Y. et al., Exp. Neurol, 170: 48-62 (2001); Vescovi, A. L. et al., Biomed. Pharmacother., 55:201-205 (2001); Cameron, H. A. and McKay, R. D., J. Comp. Neurol., 435:406-417 (2001); and Geuna, S. et al., Anat. Rec, 265: 132-141 (200 I)). Experimental strategies now are underway to transplant neuronal stem into adult brain for various therapeutic indications (Kurimoto, Y. et al., Neurosci. Leu., 306:57-60 (2001); Singh, G., Neuropathology, 21:110-114 (2001); and Cameron, H. A. and McKay, R. D., Nat. Neurosci., 2:894-897 (1999)). Much already is known about neurogenesis in embryonic stages of development (Saitoe, M. and Tully, T., “Making connections between synaptic and behavioral plasticity in Drosophila”, In Toward a Theory of Neuroplasticity, J. McEachem and C. Shaw, Eds. (New York: Psychology Press.), pp. 193-220 (2000)). Neuronal differentiation, neurite extension and initial synaptic target recognition all appear to occur in an activity-independent fashion.

Whether in adults or in the young, compounds that function to improve learning and memory would find immediate acceptance and use in the market place.

The present application explores the intersection of compounds that enhance neurite outgrowth and their effect on memory.

### SUMMARY OF THE INVENTION

Long term memory can be enhanced with compounds that stimulate CREB pathway activity and enhance neurite outgrowth. One embodiment of the disclosed invention relates to a method for identifying a compound that enhances memory, comprising: selecting a candidate compound from a library that induces neurite outgrowth and which also enhances CREB pathway function, whereby the compound which both induces neurite outgrowth and enhances CREB pathway function is identified as the compound that enhances memory. The step of selecting the candidate compound that induces neurite outgrowth, comprises, providing to a neurite host cell with either the candidate compound or a control compound; measuring cell growth in response to the candidate compound and the control compound; and observing a difference in cell growth between the candidate compound and the control compound; whereby the candidate compound which effects a positive change in cell growth is identified as a compound that enhances neurite outgrowth. The neurite host cells used in the method can be a Neuroscreen 1 cell, a mouse hippocampal neuron, or a neuroblastoma Neuro2a cell. The host cell can further comprises a CREB reporter construct, and the candidate compound also upregulates the CREB reporter construct.

In one aspect of the embodiment, the step of selecting the candidate compound that enhances CREB pathway function, comprises: contacting host cells comprising an indicator gene operably linked to a CRE promoter with a candidate compound, thereby producing a test sample; contacting the test sample with a suboptimal dose of a CREB function stimulating agent; determining indicator activity in said host cells which have been contacted with said test compound and with said CREB function stimulating agent; comparing the indicator activity with the indicator activity in control cells which have been contacted with said CREB function stimulating agent and which have not been contacted with said test compound; and selecting said test compound If: 1) the indicator activity determined in step c) is increased relative to the indicator activity in said control cells which have been contacted with said CREB function stimulating agent and which have not been contacted with said test compound; and 2) the indicator activity in control cells which have not been contacted with said CREB function stimulating agent and which have been contacted with said test compound is not significantly different relative to the indicator activity in control cells which have not been contacted with said CREB function stimulating agent and which have not been contacted with said test compound.

Another aspect of the embodiment, further comprising the steps of repeating steps a) to e) with a range of different concentrations of said test compound selected in step e); selecting said test compound If: 1) the indicator activity is increased in the range of different concentrations for said test compound relative to the indicator activity in said control cells which have been contacted with said CREB function stimulating agent and which have not been contacted with said test compound; and 2) the indicator activity in control cells to which have not been contacted with said CREB function stimulating agent and which have been introduced said range of different concentrations of said test compound is not significantly different relative to the indicator activity in control cells which have not been contacted with said CREB pathway function stimulating agent and which have not been contacted with said test compound, thereby selecting a candidate compound; contacting cells of neural origin with said candidate compound selected in step g) and with a suboptimal dose of a CREB function stimulating agent; assessing endogenous CREB-dependent gene expression in the cells which have been contacted with said candidate compound and with said CREB function stimulating agent; comparing endogenous CREB-dependent gene expression assessed in step i) with endogenous CREB-dependent gene expression in control cells which have been contacted with said CREB function stimulating agent and which have not been contacted with said candidate compound; selecting said candidate compound If: endogenous CREB-dependent gene expression assessed in step i) is increased relative to endogenous CREB-dependent gene expression in control cells which have been contacted with said CREB function stimulating agent and which have not been contacted with said candidate compound; and 2) endogenous CREB-dependent gene expression in control cells which have not been contacted with said CREB function stimulating agent and which have been contacted with said candidate compound is not significantly different relative to the CREB-dependent gene expression in control cells which have not been contacted with said CREB function stimulating agent and which have not been contacted with said candidate compound, thereby selecting a confirmed candidate compound; 1) administering said confirmed candidate compound selected in step k) to an animal; training said animal administered said confirmed candidate compound under conditions appropriate to produce long term memory formation in said animal; assessing long term memory formation in said animal trained in step m); and comparing long term memory formation assessed in step n) with long term memory formation produced in the control animal to which said confirmed candidate compound has not been administered. In another aspect, the host cells are human neuroblastoma cells and said cells of neural origin are neurons. The neurons can also be primary hippocampal cells. The indicator gene can encode luciferase. In another aspect, the CREB function stimulating agent is forskolin, steps a) to e) are repeated with a range of four different concentrations of said test compound selected in step e), or the animal can a mammal.

### BRIEF DESCRIPTION OF THE DRAWINGS

FIGS. 1A-C show bar graphs indicating the effect of CREB over-expression and Rolipram on a CRE-luciferase reporter gene as measured in relative light units (RLU).

FIG. 2A-B shows bar graphs indicated that CREB enhancement reduces the amount of training required to achieve maximal long-term memory.

FIG. 3A-C shows bar graphs indicating the impact of CREB enhancers on neurite lengths.

FIG. 4A-B shows the effect of HT-2175 and a novel CREB enhancer on neurite outgrowth in mouse hippocampal neurons and on hippocampal memory.

FIG. 5A-C shows bar graphs indicating the effect of Gpr12 siRNA on neurite outgrowth and memory.

FIG. 6 A-D shows line and bar graphs indicating the effect of the GalR3 receptor antagonist HT-2157 on neurite outgrowth and contextual memory.

FIG. 7A-B shows bar graph illustrating the effect of GAB A-receptor (FIT-1974) and monoamine oxidase B (HT-1060) inhibitors on neurite outgrowth in NS1 cells.

### DETAILED DESCRIPTION OF THE INVENTION

The disclosed invention relates to cell based screening assays that are useful to identify compounds that enhance memory in normal and memory impaired individuals. Molecular studies have begun to elucidate the biochemistry memory. Memory can generally be divided into long-term memory (LTM) or consolidated memory and short-term memory (STM) or working memory. One significant phenotypic difference between the two types of memory is that LTM involves the synthesis of new proteins. Accordingly, the generation of LTM involves different biochemical pathways from those utilized in STM.

The disclosed invention uses a multi-step screening process that rapidly identifies compounds with activity against the biochemical pathways involved in LTM acquisition. The compounds identified by these screening processes are capable of enhancing memory in normal subjects, memory impaired subjects, or both.

The methods described herein exploit an observed correlation between enhanced memory, the cyclic adenosine monophosphate (cAMP) response element-binding (CREB) system, and neurite outgrowth. Compounds that activate the CREB pathway and induce neurite outgrowth are contemplated as having utility to enhance memory, particularly LTM memory.

### CREB Pathway Assay

One step of the described screening process involves the use of a cyclic adenosine monophosphate (cAMP) response element-binding (CREB) screening system. Any system capable of monitoring or reporting increases in CREB pathway activity can be used with the disclosed methods. An exemplary system is described in U.S. patent application Ser. No. 10/527,950, entitled, “Screening methods for cognitive enhancers,” which is hereby incorporated by reference in its entirety.

In that method, host cells comprising an indicator gene operably linked to a CRE promoter are contacted with a test compound, thereby producing a test sample. The test sample is then contacted with a suboptimal dose of a CREB function stimulating agent and the activity of an indicator in the host cells is determined by comparing the indicator activity with the indicator activity in control cells.

The presently described methods are useful to identify or screen compounds that enhance the CREB pathway and promote neurite outgrowth, which are referred to herein as memory enhancers. The described methods provide high throughput cell-based methods (assays) to identify or screen for memory enhancers that act by increasing CREB pathway function.

Memory enhancers can increase, enhance or improve CREB pathway function by a variety of mechanisms. For example, a memory enhancer can affect a signal transduction pathway which leads to induction of CREB-dependent gene expression. Induction of CREB-dependent gene expression can be achieved, for example, via up-regulation of positive effectors of CREB function and/or down-regulation of negative effectors of CREB function. Positive effectors of CREB function include adenylate cyclases and CREB activators. Negative effectors of CREB function include cAMP phosphodiesterase (cAMP PDE) and CREB repressors.

A memory enhancer can increase, enhance or improve CREB pathway function by acting biochemically upstream of or directly acting on an activator or repressor form of a CREB protein and/or on a CREB protein containing transcription complex. For example, CREB pathway function can be affected by increasing CREB protein levels transcriptionally, post-transcriptionally, or both transcriptionally and post-transcriptionally, by altering the affinity of CREB protein to other necessary components of the of the transcription complex, such as, for example, to CREB-binding protein (CBP protein); by altering the affinity of a CREB protein containing transcription complex for DNA CREB responsive elements in the promoter region; or by inducing either passive or active immunity to CREB protein isoforms. The particular mechanism by which a memory enhancer increases, enhances or improves CREB pathway function is not critical to the practice of the disclosed methods.

By “increase CREB pathway function” or “enhance CREB pathway function” is meant the ability to increase, enhance or improve CREB-dependent gene expression. By “modulate CREB pathway function” is meant the ability to modulate CREB-dependent gene expression. CREB-dependent gene expression can be increased, enhanced or improved by increasing endogenous CREB production, for example by directly or indirectly stimulating the endogenous gene to produce increased amounts of CREB, or by increasing functional (biologically active) CREB. See, e.g., U.S. Pat. No. 5,929,223; U.S. Pat. No. 6,051,559; and International Publication No. WO96/11270 (published Apr. 18, 1996), which references are incorporated herein in their entirety by reference. By “increasing functional (biologically active) CREB” is meant to include the ability to increase DNA binding ability, phosphorylation state, protein stability, subcellular localization, etc. CREB-dependent gene expression can be modulated by increasing or decreasing endogenous CREB production, for example by directly or indirectly stimulating the endogenous gene to produce increased or decreased amounts of CREB, or by increasing or decreasing functional (biologically active) CREB.

In a preferred, methods for identifying or screening for memory enhancers comprise a cell-based method used to identify candidate compounds that act as memory enhancers.

An example of such a screen comprises: (a) contacting host cells comprising an indicator gene operably linked to a CRE promoter with a test compound and with a suboptimal dose of a stimulating agent that activates signaling pathways onto CREB; (b) determining indicator activity in host cells which have been contacted with the test compound and with the stimulating agent; (c) comparing the indicator activity determined in step (b) with the indicator activity in control cells which have been contacted with the stimulating agent and which have not been contacted with the test compound (control cells which have been contacted with stimulating agent alone); (d) selecting the test compound If (1) the indicator activity determined in step (b) is statistically significantly increased relative to the indicator activity in the control cells of step (c); and (2) the indicator activity in control cells which have not been contacted with the stimulating agent and which have been contacted with the test compound (control cells contacted with test compound alone) is not statistically significantly different relative to the indicator activity in control cells which have been contacted with neither the stimulating agent or the test compound (controls cells which have been contacted with nothing); (e) repeating steps (a) to (d) with a range of different concentrations of the test compound selected in step (d); and (f) selecting the test compound if: (1) the indicator activity is proportionally statistically significantly increased in the range of different concentrations of said test compound relative to the indicator activity in the control cells to which have been contacted with the stimulating agent alone; and (2) the indicator activity in control cells to which have been introduced the range of different concentrations of the test compound alone is not significantly different relative to the indicator activity in control cells which have not been contacted with either the stimulating agent or the test compound, wherein the test compound is identified as a candidate compound. In a particular embodiment, the test compound is selected in step (f) if (1) the indicator activity is proportionally significantly increased in the linear range of different concentrations for the test compound; and (2) the indicator activity in control cells to which have been introduced the range of different concentrations of the test compound alone is not significantly different relative to the indicator activity in control cells which have not been contacted with either the stimulating agent or the test compound. In another embodiment, host cells are contacted with the test compound prior to contact with the stimulating agent.

In an alternative embodiment, the screen comprises: (a) contacting host cells with a test compound and with a suboptimal dose of a stimulating agent that activates signaling pathways onto CREB; (b) assessing endogenous CREB-dependent gene expression in the host cells which have been contacted with the test compound and with the stimulating agent; (c) comparing endogenous CREB-dependent gene expression assessed in step (b) with endogenous CREB-dependent gene expression in control cells which have been contacted with the stimulating agent and which have not been contacted with the test compound (control cells which have been contacted with stimulating agent alone); (d) selecting the test compound If (1) the endogenous CREB-dependent gene expression determined in step (b) is statistically significantly increased relative to the endogenous CREB-dependent gene expression in the control cells of step (c); and (2) the CREB-dependent gene expression in control cells which have not been contacted with the stimulating agent and which have been contacted with the test compound (control cells which have been contacted with test compound alone) is not statistically significantly different relative to the CREB-dependent gene expression in control cells which have been contacted with neither the stimulating agent or the test compound (controls cells which have been contacted with nothing); (e) repeating steps (a) to (d) with a range of different concentrations of the test compound selected in step, (d); and (f) selecting the test compound If: (1) the CREB-dependent gene expression is proportionally statistically significantly increased in the range of different concentrations for said test compound relative to the CREB-dependent gene expression in the control cells which have been contacted with the stimulating agent alone; and (2) the CREB-dependent gene expression in control cells to which have been introduced the range of different concentrations of the test compound alone is not significantly different relative to the CREB-dependent gene expression in control cells which have been contacted with neither the stimulating agent or the test compound, wherein the test compound is identified as a candidate compound. In a particular embodiment, the test compound is selected in step (f) if (1) the CREB-dependent gene expression is proportionally significantly increased in the linear range of the different concentrations for the test compound; and (2) the CREB-dependent gene expression in control cells to which have been introduced the range of different concentrations of the test compound alone is not significantly different relative to the CREB-dependent gene expression in control cells which have not been contacted with either the stimulating agent or the test compound. In another embodiment, host cells are contacted with the test compound prior to contact with the stimulating agent.

Preferably, the “stimulating agent that activates signaling pathways onto CREB” used in the primary screen is a CREB function stimulating agent. A CREB function stimulating agent is an agent that is able to stimulates CREB pathway function. By “stimulate CREB pathway function” is meant the ability to stimulate CREB-dependent gene expression by stimulating endogenous CREB production, for example by directly or indirectly stimulating the endogenous gene to produce increased amounts of CREB, or by increasing functional (biologically active) CREB. See, e.g., U.S. Pat. No. 5,929,223); U.S. Pat. No. 6,051,559; and International Publication No. WO96/11270 (published Apr. 18, 1996), which references are incorporated herein in their entirety by reference. “CREB function stimulating agents” include drugs, chemical compounds, ionic compounds, organic compounds, organic ligands, including cofactors, saccharides, recombinant and synthetic peptides, proteins, peptoids, nucleic acid sequences, including genes, nucleic acid products, and other molecules and compositions. CREB function stimulating agents can be activators of adenylate cyclase 1 (AC1) (e.g., forskolin); cell permeant cAWP analogs (e.g, 8-bromo cAW); agents (neurotransmitters) affecting G-protein linked receptor, such as, but not limited to adrenergic receptors and opioid receptors and their ligands (e.g., isoproterenol, phenethylamines); modulators of intracellular calcium concentration (e.g., potassium chloride, thapsigargin, N-methyl-D-aspartate (NMDA) receptor agonists); inhibitors (antagonists) of the phosphodiesterases responsible for cAMP breakdown (e.g., rolipram (which inhibits phosphodiesterase 4), iso-buto-metho-xanthine (IBMX) (which inhibits phosphodiesterases 1 and 2)); modulators (agonists) of protein kinases and protein phosphatases, which mediate CREB protein activation and CREB-dependent gene expression. CREB function stimulating agents can also be compounds which are capable of enhancing CREB function in the central nervous system (CNS). Such compounds include, but are not limited to, compounds which affect membrane stability and fluidity and specific immunostimulation.

Signaling pathways that activate onto CREB include the mitogen-activated protein kinase (MAPK) signaling pathway and protein kinase A (PKA). Thus, stimulating agents that activate signaling pathways onto CREB include inhibitors of MAPK/Erk kinase (MEK). Other stimulating agents that activate signaling pathways onto CREB are known and readily available to those skilled in the art.

In another embodiment, the CREB pathway screen can be replaced with a screening method using Drosophila, wherein said screening method comprises: (a) administering a test compound to Drosophila having an indicator gene operably linked to a CRE promoter; (b) assessing indicator activity in the Drosophila to which have been administered the test compound; and (c) comparing the indicator activity assessed in step (b) with the indicator activity in control Drosophila to which have not been administered the test compound. A statistically significant difference in indicator activity in step (b) compared to the indicator activity in control Drosophila to which have not been administered the test compound identifies the test compound as a candidate compound.

Host cells comprising an indicator gene operably linked to a CRE promoter can be manufactured by introducing into cells a DNA construct comprising an indicator gene operably linked to a CRE promoter. DNA constructs can be introduced into cells according to methods known in the art (e.g., transformation, direct uptake, calcium phosphate precipitation, electroporation, projectile bombardment, using liposomes). Such methods are described in more detail, for example, in Sambrook et al., Molecular Cloning: A Laboratory Manual, 2nd edition (New York: Cold Spring Harbor University Press) (1989); and Ausubel, et al., Current Protocols in Molecular Biology (New York: John Wiley & Sons) (1998).

As used herein, a cell refers to an animal cell. The cell can be a stem cell or somatic cell. Suitable animal cells can be of, for example, mammalian origin. Examples of mammalian cells include human (such as HeLa cells), bovine, ovine, porcine, rodent (such as rat, murine (such as embryonic stem cells), rabbit etc.) and monkey (such as COSI cells) cells. Preferably, the cell is of neural origin (such as a neuroblastoma, neuron, neural stem cell, glial cell, etc.). The cell can also be an embryonic cell, bone marrow stem cell or other progenitor cell. Where the cell is a somatic cell, the cell can be, for example, an epithelial cell, fibroblast, smooth muscle cell, blood cell (including a hematopoietic cell, red blood cell, T-cell, B-cell, etc.), tumor cell, cardiac muscle cell, macrophage, dendritic cell, neuronal cell (e.g., a glial cell or astrocyte), or pathogen-infected cell (e.g., those infected by bacteria, viruses, virusoids, parasites, or prions). The cells can be obtained commercially or from a depository or obtained directly from an animal, such as by biopsy.

Drosophila comprising an indicator gene operably linked to a CRE promoter can be produced as described by Belvin et al., Neuron, 22(4):777-787 (1999).

DNA constructs comprising an indicator gene operably linked to a CRE promoter can be manufactured as described in, for example, Ausubel et al., Current Protocols In Molecular Biology (New York: John Wiley & Sons) (1998); and Sambrook et al., Molecular Cloning: A Laboratory Manual, 2nd edition (New York: Cold Spring Harbor University Press (1989).

As used herein, the term “promoter” refers to a sequence of DNA, usually upstream (5^{T}) of the coding region of a structural gene, which controls the expression of the coding region by providing recognition and binding sites for RNA polymerase and other factors which may be required for initiation of transcription. CRE promoters are known in the art.

The term “indicator gene”, as used herein, refers to a nucleic acid sequence whose product can be easily assayed, for example, colorimetrically as an enzymatic reaction product, such as the gene encoding luciferase. Other examples of widely used indicator genes include those encoding enzymes, such as .beta.-galactosidase, .beta.-glucoronidase and .beta.-glucosidase; luminescent molecules, such as green fluorescent protein and firefly luciferase; and auxotrophic markers such, as His3p and Ura3p. See, e.g., Ausubel et al., Current Protocols In Molecular Biology (New York: John Wiley & Sons, Inc.), Chapter 9 (1998)).

Cells (e.g., host cells, cells of neural origin, etc.) contacted with a test compound and/or CREB function stimulating agent will take up the test compound and/or CREB function stimulating agent.

By “suboptimal dose of CREB function stimulating agent” is meant that amount, or dose, of CREB function stimulating agent that is required to stimulate (induce) CREB pathway function to a level that is above endogenous (basal) levels, such that a further statistically significant increase in CREB pathway function due to induction by a memory enhancer can be measured and the measurement is not attributable to natural cellular fluctuations or variations as a consequence of natural cellular fluctuations. A suboptimal dose of CREB function stimulating agent is that dose or concentration where the amount of the effect (indicator activity, CREB-dependent gene expression) is proportional to the dose or concentration and the amount of the effect does not change when the dose or concentration changes. The suboptimal dose of CREB function stimulating agent is determined empirically and will vary depending upon a variety of factors, including the pharmacodynamic characteristics of the particular CREB function stimulating agent and the particular cells to be contacted. For example, the suboptimal dose of CREB function stimulating agent can be determined by (a) contacting different samples of a host cell comprising an indicator gene operably linked to a CRE promoter with a different concentration of the CREB function stimulating agent; and (b) determining the range of concentrations of CREB function stimulating agent required to affect indicator activity from baseline to maximal response by assessing indicator activity in the samples of the host cell. The suboptimal dose of CREB function stimulating agent will be any concentration yielding (1) 50% or less maximal indicator activity and (2) an indicator activity above natural cellular fluctuations. Determination of the suboptimal dose of CREB function stimulating agent is well within the ability of those skilled in the art. By “suboptimal dose of a stimulating agent that activates signaling pathways onto CREB” is meant that amount, or dose, of stimulating agent that is required to stimulate (induce) a signaling pathways onto CREB.

By “range of different concentrations of the test compound” is meant 2 or more (i.e., 2, 3, 4, 5, etc.) different concentrations of the test compound. The range of concentrations selected generally flanks the concentration of the test compound in step (a) of the primary screen. By “linear range of (different) concentrations” is meant the concentrations where effect (indicator activity, CREB-dependent gene expression) is increasing with concentration but prior to when the effect is no longer changing with concentration changes. Selecting concentration ranges is well within the ability of those skilled in the art.

By “functional (biologically active) CREB” is meant to include the protein's DNA binding ability, phosphorylation state, protein stability, subcellular localization, etc.

“CREB-dependent gene expression” is also referred to herein as “CRE-mediated gene expression”. CREB-dependent gene expression can be determined by methods known in the art (e.g., Northern blot, Western blot). Such methods are described in more detail, for example, in Ausubel et al., Current Protocols In Molecular Biology (New York: John Wiley & Sons) (1998); and Sambrook et al., Molecular Cloning: A Laboratory Manual, 2nd edition (New York: Cold Spring Harbor University Press (1989).

“Endogenous CRE-mediated genes” are also referred to herein as “endogenous CREB-dependent genes”. Such genes are known in the art and include, for example, c-fos, prodynorphin, tPA and brain-derived neurotrophic factor (BDNF) (Barco, A. et al., Cell, 108(5):689-703 (2002)). CRE-mediated genes can also be identified by those skilled in the art using methods known and readily available in the art (see, e.g., Ausubel et al., Current Protocols In Molecular Biology (New York: John Wiley & Sons) (1998); and Sambrook et al., Molecular Cloning: A Laboratory Manual, 2nd edition (New York: Cold Spring Harbor University Press (1989)).

The methods contemplated herein further comprise the use of additional or secondary screen, such as using host cells of neural origin with a candidate compound identified in the CREB pathway screen. In one embodiment, the host cells in the CREB pathway screen are proliferating cells, such as neuroblastoma cells, and the cells in the secondary screen are nonproliferating, differentiated cells of neural origin (such as neurons (e.g., primary hippocampal cells) and glial cells). In a particular embodiment, the CRE-mediated gene in the primary screen is a CRE-mediated indicator gene (a CRE-mediated transgene) and the CRE-mediated gene in the secondary screen is an endogenous CRE-mediated gene.

Compounds observed to activate the CREB pathway in a host cell containing a reporter system are referred to as “Confirmed Active compound” or “candidate compounds”. A candidate compound can be assessed or evaluated for its effect on endogenous, CRE-mediated gene expression (endogenous CREB-dependent gene expression) by, for example, (a) contacting neurons (particularly hippocampal cells) with the Confirmed Active compound (or the candidate compound), thereby producing a sample; (b) contacting the sample with a suboptimal dose of a CREB function stimulating agent; (c) assessing endogenous CREB-dependent gene expression in the neurons which have been contacted with the Confirmed Active compound (or candidate compound) and the CREB function stimulating agent; and (d) comparing endogenous CREB-dependent gene expression assessed in step (c) with endogenous CREB-dependent gene expression in control neurons which have been contacted with the CREB function stimulating agent and which have not been contacted with the Confirmed Active compound (or candidate compound). A statistically significant difference in CREB-dependent gene expression assessed in step (c) compared to the CREB-dependent gene expression in control cells identifies the Confirmed Active compound (or candidate compound) as having an effect on CREB-dependent gene expression and as a confirmed candidate compound. Preferably, no significant difference is obtained in CREB-dependent expression in control cells which have not been contacted with the CREB function stimulating agent and which have been contacted with the Confirmed Active compound (or candidate compound) (control cells which have been contacted with Confirmed Active compound (or candidate compound) alone) relative to CREB-dependent gene expression in control cells which have been contacted with neither the CREB function stimulating agent or the Confirmed Active compound (candidate compound) (control cells which have been contacted with nothing).

As described herein, confirmed candidate compounds and memory enhancers from several chemical classes are progressed through in vivo models of memory formation.

Compounds to be evaluated or assessed for their ability to increase CREB pathway function, such as pharmaceutical agents, drugs, chemical compounds, ionic compounds, organic compounds, organic ligands, including cofactors, saccharides, recombinant and synthetic peptides, proteins, peptoids, nucleic acid sequences, including genes, nucleic acid products, and other molecules and compositions, can be individually screened or one or more compound(s) can be tested simultaneously for the ability to increase CREB pathway function in accordance with the methods herein. Where a mixture of compounds is tested, the compounds selected by the methods described can be separated (as appropriate) and identified by suitable methods (e.g., chromatography, sequencing, PCR). The presence of one or more compounds in a test sample having the ability to increase CREB pathway function can also be determined according to these methods. Compounds to be screened for their ability to increase CREB pathway function are generally at a concentration from about 16⁹ molar to about 16³ molar.

Large combinatorial libraries of compounds (e.g., organic compounds, recombinant or synthetic peptides, peptoids, nucleic acids) produced by combinatorial chemical synthesis or other methods can be tested (see e.g., Zuckerman, R. N. et al., J. Med. Chem., 37:2678-2685 (1994) and references cited therein; see also, Ohlmeyer, M. H. J. et al., Proc. Natl. Acad. Sci. USA, 90:10922-10926 (1993) and DeWitt, S. H. et al., Proc. Natl. Acad. Sci. USA, 90:6909-6913 (1993), relating to tagged compounds; Rutter, W. J. et al. U.S. Pat. No. 5,010,175; Huebner, V. D. et al., U.S. Pat. No. 5,182,366; and Geysen, H. M., U.S. Pat. No. 4,833,092). The teachings of these references are incorporated herein by reference. Where compounds selected from a combinatorial library carry unique tags, identification of individual compounds by chromatographic methods is possible.

Chemical libraries, microbial broths and phage display libraries can also be tested (screened) for the presence of one or more compounds which is capable of enhancing CREB pathway function in accordance with the methods herein.

The confirmed candidate compound are also assessed to evaluate neurite outgrowth.

### Neurite Outgrowth Assay

Another step of the screening process involves determining the ability of a Confirmed Active or candidate compound that demonstrated CREB pathway activity to induce neurite outgrowth. A variety of neurite outgrowth assays are known in the art that measure increased length in neurite cell processes. For example, U.S. Pat. Nos. 7,282,340 and 7,452,863, which are hereby incorporated by reference in their entirety, describes a neurite outgrowth assays. A variety of different cell types can be used in the assay, for example, PC 12 cells, which are derived from a pheochromocytoma of the rat adrenal medulla. PC 12 cells are known as being useful as a model system for neuronal differentiation. In one embodiment of the neurite outgrowth assay uses neuroblastoma cells which are known to develop long axonal-like processes upon exposure to certain compounds, such as NGF.

### Long Term Memory Formation

Compounds identified as increasing CREB pathway activity and inducing neurite outgrowth are then tested for the ability to impact long term memory formation. Contextual fear conditioning is an example of a method for assessing LTM formation. Typically, long term memory formation testing occurs using an animal model, comprising: (a) administering an effective amount of a confirmed candidate compound identified in the assays discussed above to the animal (e.g., human, other mammal, vertebrate or invertebrate); (b) training the animal administered the confirmed candidate compound under conditions appropriate to produce long term memory formation in the animal; (c) assessing long term memory formation in the animal trained in step (b); and (d) comparing long term memory formation assessed in step (c) with long term memory formation produced in the control animal to which the confirmed candidate compound has not been administered. If an enhancement is noted in long term memory formation assessed in the animal treated with the confirmed candidate compound relative to the long term memory formation assessed in the control animal the confirmed candidate compound is identified as a memory enhancer. LTM screens with similar protocols are available using behavioral methods (models) for other, cognitive dysfunctions.

The combination of these assays permits the identification of compounds that both stimulate neurite outgrowth and impact the CREB pathway. Compounds capable of affecting both of these systems will improve memory in normal subjects as well as those suffering from various memory deficits.

The following examples are offered to illustrate but not to limit the invention.

### Example 1

### CREB Assay

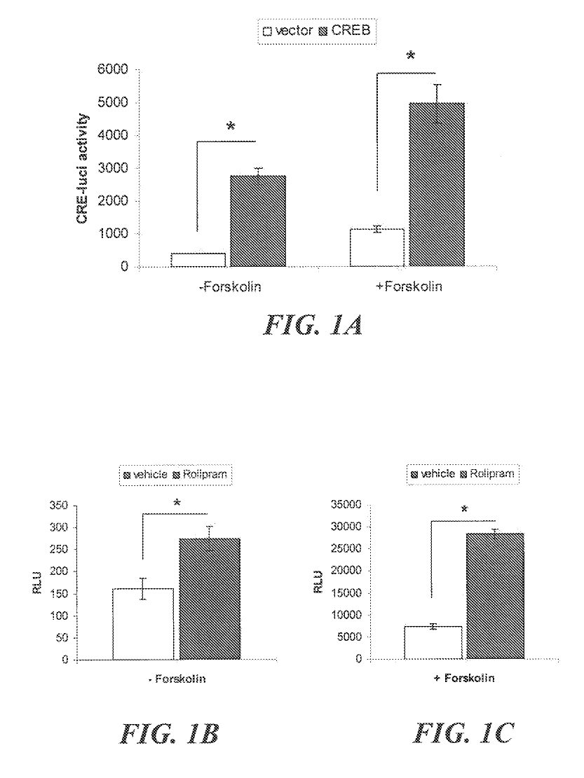

CREB activity assays were constructed. Neuro2A cells were transfected with a CREB expressing or control vectors using standard molecular biology techniques. CRE-luciferase activity was monitored in the presence or absence of Forskolin (PPCA activator). The data from this experiment is shown in FIG. 1A. CREB over-expression led to an increase in the activation of the CRE-reporter construct (n=3 per group, * indicates p<0.05). CRE-luciferase reporter thus measures activation of the CREB pathway. In FIG. 1B, the effect of Rolipram on CREB-activation is shown. Neuro2A cells were treated with the PDE4 inhibitor Rolipram and CREB activation monitored via CRE-liciferase activation. Rolipram activates CREB-dependent transcription, identifying it as a CREB enhancer (n=8 per group, p<0.001).

The effect of Rolipram on CREB-activation was assayed in the presence of 0.5 μM Forskolin. Neuro2A cells were treated with the PDE4 inhibitor Rolipram and CREB activation monitored via CRE-liciferase activation in the presence of 0.5 μM Forskolin. Again, and in analogy to CREB overexpression (FIG. 1A), Rolipram activates CREB-dependent transcription (n=7 for vehicle, n=8 for Rolipram, p<0.001). These data identify Rolipram as a CREB enhancer.

### Example 2

### CREB Enhancement and LTM

The effect of administering a CREB enhancing compound on long term memory (LTM) was examined.

Young-adult (10-12 weeks old) C57BL16 male mice (Taconic, N.Y.) were used for biochemistry and behavioral experiments. Upon arrival, mice were group-housed (5 mice) in standard laboratory cages and maintained on a 12:12 hours light-dark cycle. The experiments were always conducted during the light phase of the cycle. The day before the initiation of the experiment, mice were single housed in individual cages and maintained so till the end of the experiment. With the exception of training and testing times, the mice had ad lib access to food and water.

To assess contextual memory, a standardized contextual fear conditioning task (Bourtchuladze, et al., Cell 79(1):59-68 (1994)) was used. On the training day, the mouse was placed into the conditioning chamber (Med Associates, Inc., VA) for 2 minutes before the onset of the unconditioned stimulus (US), a 0.5 mA foot shock of 2 seconds duration. The US was repeated with a 1 minute inter-trial interval between shocks. After the last training trial, the mice were left in the conditioning chamber for another 30 sec and were then placed back in their home cage. Memory retention was tested one or four days after training. Results were identical for both time points. The mouse was placed into the same training chamber and conditioning was assessed by scoring freezing behavior, as defined by the complete lack of movement. Total testing time lasted 3 minutes. The proceeding of each experiment was filmed. After each experimental subject, the experimental apparatus was thoroughly cleaned with 75% ethanol, water, dried, and ventilated.

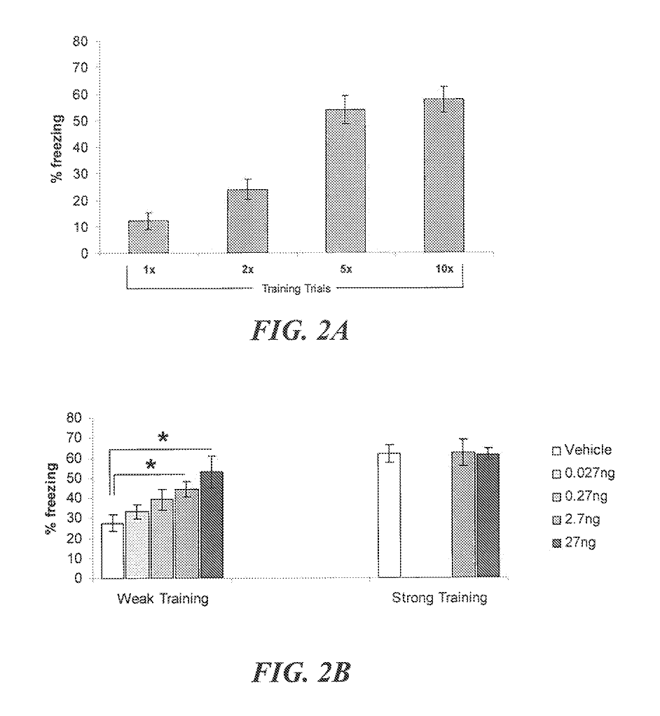

Mice were trained with one, two, five or ten trials of contextual conditioning. Four days later contextual memory was tested by scoring freezing behavior. Data is shown in FIG. 2A. When compared to memory after a single trial, training with multiple trials significantly facilitates contextual memory. Maximal memory was achieved with five training trials. Next, mice received weak training (two trials) to induce submaximal memory, or strong training (five trials) to induce maximum memory. Directly after training, the CREB enhancer Rolipram or vehicle was injected into the hippocampus. Contextual memory was tested by scoring freezing behavior four days after training. The CREB enhancer Rolipram dose-dependently facilitates submaximal contextual memory after weak training, but has no effect on maximal memory after strong training. Thus, CREB enhancement is sufficient to facilitate memory formation after suboptimal training, but does not affect maximal memory.

### Example 3

### CREB Enhancer and Neurite Outgrowth

The effect of CREB enhancers on neurite outgrowth in NS1 cells was assayed. On-target siRNAs (Dharmacon Inc., Lafayette, USA) were used for in vitro testing (neurite outgrowth in NS 1 cells). Neuroscreen 1 (NS1) cells (Cellomics Inc.) were transfected according to the manufactures specification using Dharmafect 3.

Neuroscreen 1 (NS1) cells were cultured on collagen type I coated 75 cm² plastic flasks (Biocoat, Becton Dickinson) in a humidified incubator at 37° C. in 5% CO₂. Cells were cultured in RPMI complete cell culture medium (Cambrex) supplemented with 10% heat-inactivated horse serum (Invitrogen), 5% heat-inactivated fetal bovine serum (Cellgro), and 2 mM L-glutamine (Cambrex). For expansion, the cells were trypsinized and split at 80% confluence. The cell culture media was changed every 2 to 3 days.

NS1 cells were harvested as if they were being passaged and then counted using a Coulter counter (Becton Dickinson Coulter Z1). Cells were seeded in 96-well collagen I coated plates at a density of 2000 cells per well in volume of 200 μl. RPMI media was supplemented with 200 ng/ml nerve growth factor (NGFβ, Sigma). NS 1 cells were incubated for 72 hours to allow differentiation to a neuronal phenotype. NGFβ was then diluted to 50 ng/ml and the cells were treated with siRNA or compound at the indicated doses, respectively.

Neurite outgrowth assays were performed using the Cellomics Arrayscan II Vti HCS scanner. Cells were stained using the HitKit™ HCS reagent kit (Cellomics) according to the manufactures specifications. The assay is based on immunoflourescence using an antibody that has been validated to specifically label both neurites and neuronal cell bodies. Briefly, cells were fixed in 3.7% formaldehyde and nuclei stained with Hoechst dye. Cells were then washed in neurite outgrowth buffer and neurites stained with Cellomics' proprietary primary antibody for neurite outgrowth high content screening. After 1 hour of incubation with the primary antibody, the cells were washed again and then incubated with fluorescently labeled secondary antibody solution for 1 hour. Antibody-stained 96-well plates were store at 4° C. in the dark until scanning. Plates were scanned using Cellomics ArrayScan II Vti HCS scanner. The neurite outgrowth assay uses two channels to carry out the scan. Channel 1 detects the Hoechst Dye and is used by the software to identify cells and for automated focusing. Channel 2 detects the FITC fluorescence of the secondary antibody and is used by the software to calculate all data generated in reference to neurites.

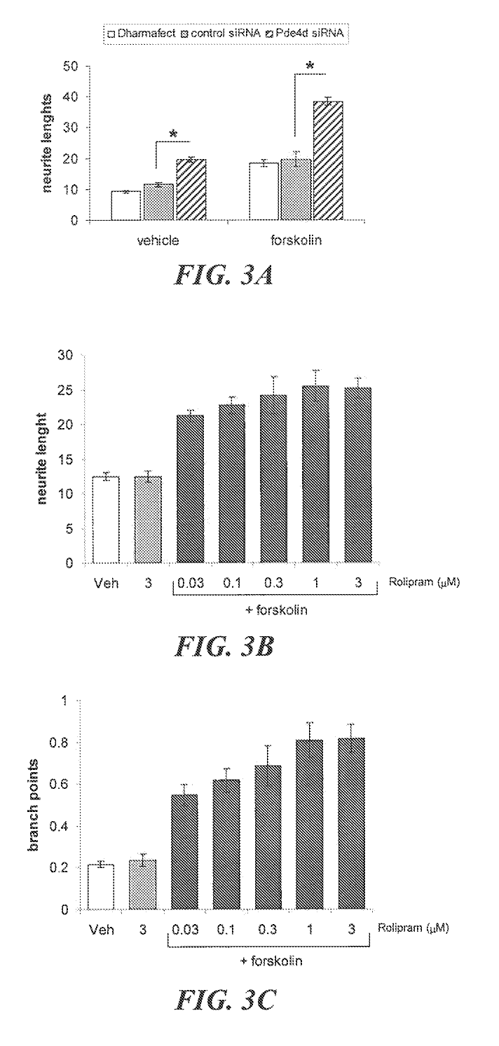

In the first set of experiments, the effect of siRNA against PDE4d (the target of Rolipram) on neurite outgrowth in NS1 cells was examined. NS1 cells were treated with vehicle alone (Dharmafect 3), non-targeting control siRNA, or PDE4d siRNA and neurite length measured 48 hours later. The data from these experiments is shown in FIG. 3 A. When compared to vehicle alone, NS1 cells treated with PDE4d siRNA had significantly longer neurites. In contrast, non-targeting control siRNA had no effect on neurite outgrowth. These findings indicate that knockdown of PDE4d, the target of the CREB enhancer Rolipram facilitates neurite outgrowth.

The next set of experiments examined the effect of the CREB enhancer Rolipram on neurite outgrowth in NS cells. NS1 cells were treated with vehicle or increasing doses of Rolipram in the presence of 5 μM Forskolin. The results are shown in FIG. 3B. Rolipram dose dependently increase neurite outgrowth as measured by increase neurite length in NS1 cells.

The effect of the CREB enhancer Rolipram on neurite outgrowth in NS cells. NS 1 cells were treated with vehicle or increasing doses of Rolipram in the presence of 5 μM Forskolin. Rolipram dose dependently increase neurite outgrowth as measured by increase neurite branch points in NS1 cells. MEAN+/−SEM of eight experimental replicate wells (each measuring neurite length of at least 100 NS1 cells) is shown for all experiments.

### Example 4

### Effect of CREB Enhancers on Neurite Outgrowth in Mouse Hippocampal Neurons and on Hippocampal Memory

For intrahippocampal Rolipram injection or Gpr12 siRNA treatment, mice were anesthetized with 20 mg/kg Avertin and implanted with a 33-gauge guide cannula bilateraly into the dorsal hippocampus (coordinates: A=−1.8 mm, L=+/−1.5 mm to a depth of 1.2 mm) (Franklin and Paxinos, 1997). Five to nine days after recovery from surgery, animals were injected with drug or vehicle control. 2 μl of drug or vehicle were injected into each hippocampus through an infusion cannula that was connected to a micro-syringe by a polyethylene tube. The entire infusion procedure took ˜2 min, and animals were handled gently to minimize stress.

HT2175 was dissolved in vehicle and administered intraperitoneally (LP.) at the indicated doses 20 minutes before training. Control animals received vehicle alone. For each training and drug-injecting procedure, an experimentally naïve group of animals were used. For intrahippocampal injection of Rolipram, 1 μL of the indicated dose of Rolipram (dissolved in 0.1% DMSO in PBS) were injected immediately after behavioral training.

To assess contextual memory, a standardized contextual fear conditioning task (Bourtchuladze, et al, Cell 79(1):59-68 (1994)) was used. On the training day, the mouse was placed into the conditioning chamber (Med Associates, Inc., VA) for 2 minutes before the onset of the unconditioned stimulus (US), a 0.5 mA foot shock of 2 seconds duration. The US was repeated with a 1 minute inter-trial interval between shocks. After the last training trial, the mice were left in the conditioning chamber for another 30 sec and were then placed back in their home cage. Memory retention was tested one or four days after training. Results were identical for both time points. The mouse was placed into the same training chamber and conditioning was assessed by scoring freezing behavior, as defined by the complete lack of movement. Total testing time lasted 3 minutes. The proceeding of each experiment was filmed. After each experimental subject, the experimental apparatus was thoroughly cleaned with 75% ethanol, water, dried, and ventilated.

All behavioral experiments were designed and performed in a balanced fashion, meaning that (i) for each experimental condition (e.g. a specific dose-effect) we used an equal number of experimental and control mice; (ii) each experimental condition was replicated several times, and replicate days were added to generate final number of subjects. The proceeding of each session was filmed. In each experiment, the experimenter was unaware (blind) to the treatment of the subjects during training and testing. Data were analyzed by Student's unpaired t test using a software package (StatView 5.0.1; SAS Institute, Inc). Biochemical data were analyzed by ANOVA. Except were indicated, all values in the text and figures are expressed as mean+SEM.

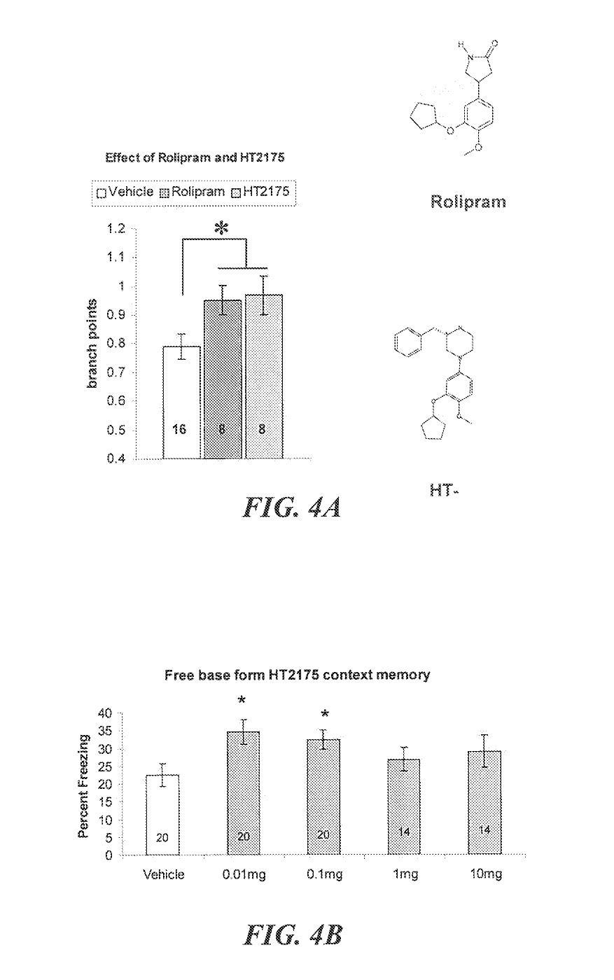

FIG. 4A-B shows the effect of HT-2175 and a novel CREB enhancer on neurite outgrowth in mouse hippocampal neurons and on hippocampal memory. FIG. A shows the effect of Rolipram and HT-2175 on neurite outgrowth in hippocampal neurons. Mouse hippocampal neurons were cultured for three days and then treated with HT-2175 or Rolipram for 24 hours. HT-2175 and Rolipram facilitate neurite outgrowth as measured by a significant enhancement of branch points per neurite. MEAN+/−SEM of eight experimental replicate wells (each measuring neurite length of at least 100 neurons) is shown. FIG. 4B shows the effect of HT-2175 on contextual memory induced by weak behavioral training (two trials). Mice were treated with HT-2175 or vehicle and then trained in contextual conditioning. HT-2175 dose dependently facilitates contextual memory, as was expected by its effect on neurite outgrowth in mouse hippocampal neurons.

### Example 5

### The Effect of Gpr12 siRNA on Neurite Outgrowth and Memory

In vivo siRNA injection was used to study the effect of Gpr12 siRNA on neurite outgrowth and memory. In vivo grade siSTABLE siRNA (Dharmacon Inc., Lafayette, USA) was used for evaluation of Gpr12 function in the mouse CNS. siRNA's were chemically modified to enhance stability. A 21mer siSTABLE non-targeting siRNA was used as control. Initial tests were performed using bDNA assay (QuantiGene bDNA assay kit, Bayer) several non-modified (siGENOME) siRNA's against Gpr12 in vitro using Neuro 2a cells. siRNA was designed using a multi component rational design algorithm (Reynolds et al, 2004) and controlled for specificity towards Gpr12 by BLAST search. The following siRNAs were chosen for further in vivo characterization:

(SEQ ID NO: 1)
Gprl2 siRNA2 sense strand
GAGGCACGCCCAUC AGAUAUU;
(SEQ ID NO: 2)
Gprl2 siRNA2 anti-sense strand
UAUCUGAUGGGCGUGCCUCUU;
(SEQ ID NO: 3)
non-targeting siRNA sense strand
UAGCGACU AAACACAUCAAUU;
and
(SEQ ID NO: 4)
non-targeting siRNA antisense strand
UUGAUGUGUUU AGUCGCU AUU.

si STABLE siRNA against Gpr12 and non-targeting control siRNA was diluted to 0.5 μg per μl in 5% glucose and mixed with 6 equivalents of a 22 kDa linear polyethyleneimine (Fermentas). After 10 minutes of incubation at room temperature, 2 μl were injected into each hippocampus through an infusion cannula that was connected to a micro-syringe by a polyethylene tube. The entire infusion procedure took ˜2 min, and animals were handled gently to minimize stress. A total of 3 infusions of siRNA were given over a period of 3 days (1 μg siRNA per hippocampus per day).

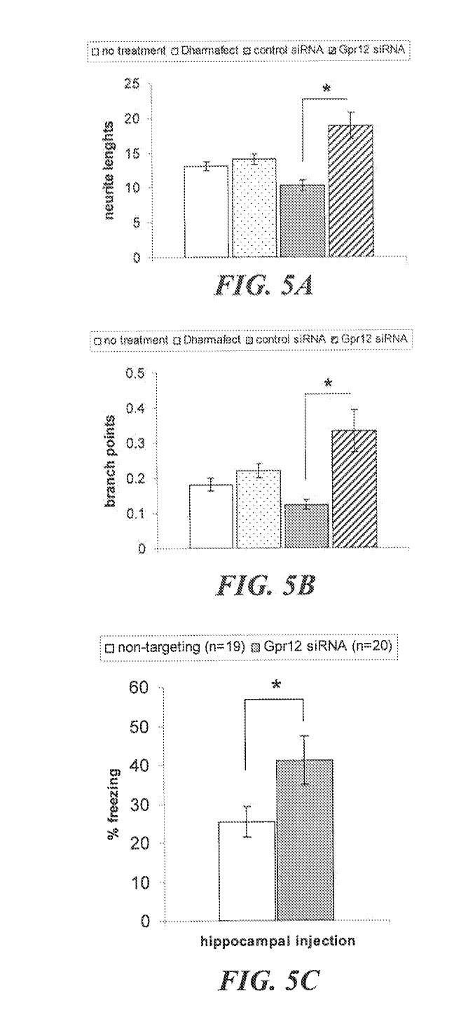

NS1 cells were treated for 48 hours with Gpr12 siRNA or non-targeting control siRNA. Neurite length was compared to cells treated with vehicle alone and untreated cells. Gpr12 siRNA significantly enhanced neurite outgrowth as measured by increased neurite length. Non-targeting control siRNA or vehicle alone had no effect on neurite length. The results are shown in FIG. 5 A. MEAN+/−SEM of eight experimental replicate wells (each measuring neurite length of at least 100 NS1 cells) is shown. FIG. 5B shows the effect of Gpr12 siRNA on branch points. NS1 cells were treated for 48 hours with Gpr12 siRNA or non-targeting control siRNA. Neurite length was compared to cells treated with vehicle alone and untreated cells. Gpr12 siRNA significantly enhanced neurite outgrowth as measured by increased number of branch points. Non-targeting control siRNA or vehicle alone had no effect on branch points. MEAN+/−SEM of eight experimental replicate wells (each measuring neurite length of at least 100 NS1 cells) is shown. FIG. 5C shows the effect of Gpr12 siRNA on memory. Mice were injected repeatedly into hippocampus with Gpr12 siRNA (n=20) or control siRNA (n=19), and then trained in contextual fear conditioning using a weak training paradigm (two trials). Memory was assessed by scoring freezing behavior 24 hours later. As expected from its effect on neurite outgrowth, Gpr12 siRNA facilitates contextual memory.

### Example 6

### The Effect of the GalR3Receptor Antagonist HT-2157 on Neurite Outgrowth and Contextual Memory

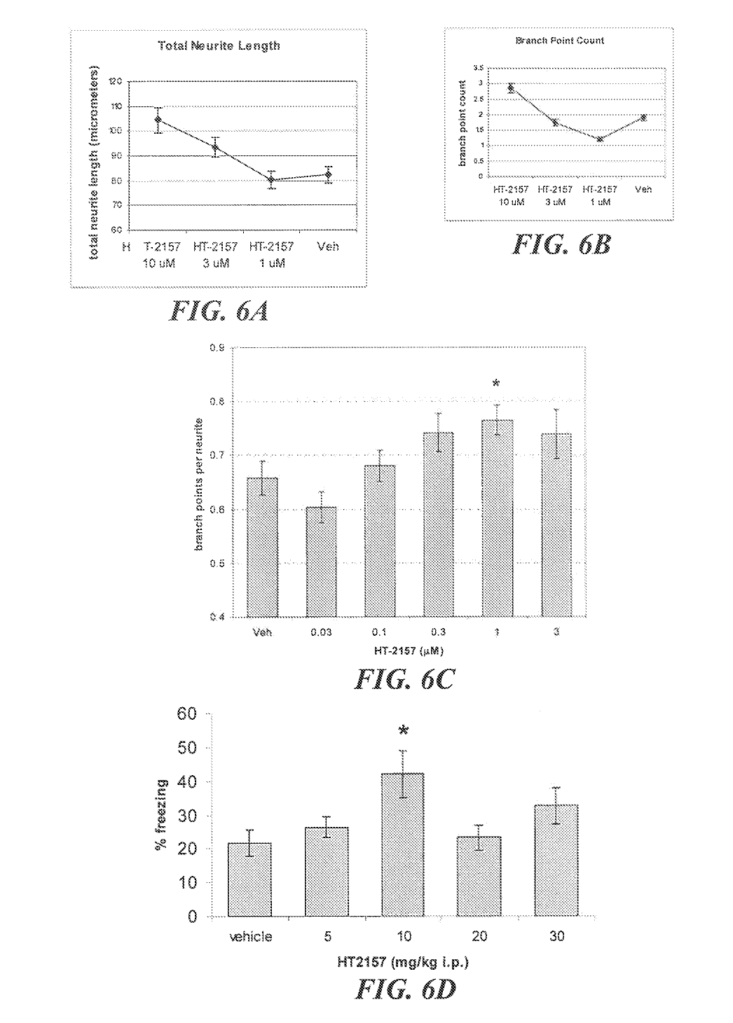

The mean±sem of 8 experimental replications per drug dose and 16 replication per vehicle are shown. For each experiment, neurite outgrowth in a minimum of 100 cells was measured. FIG. 6A shows data quantifying the effect of HT-2157 on neurite outgrowth in NS1 cells. Similar to the CREB enhancer Rolipram, HT-2157 facilitates neurite outgrowth as indicated by an increase in the total neurite length per cell. FIG. 6B shows data quantifying the effect of HT-2157 on neurite outgrowth in NS1 cells. HT-2157 facilitates neurite outgrowth as indicated by an increase in the number of branch points per dendrite. FIG. 6C shows data quantifying the effect of HT-2157 on neurite outgrowth in mouse hippocampal neurons. HT-2157 dose-dependently facilitates neurite outgrowth as indicated by an increase in the number of branch points. FIG. 6D shows data regarding the effect of HT-2157 on contextual memory. Mice were treated with HT-2157 at the indicated doses or with control vehicle and trained in contextual fear conditioning with two trials. As was expected from the neurite outgrowth assay, HT-2157 dose dependently facilitates contextual memory.

### Example 7

### The Effect of GAB A-Receptor and Monoamine Oxidase B Inhibitors on Neurite Outgrowth in NS1 Cells

Cryo-preserved NS 1 neurons were purchased from the University of Ottawa. Neurons were cultured on poly-D-lysine coated 96 well plates in serum free Neurobasal medium supplemented with 2% B27, 500 μM L-glutamine, and 1 mM pyruvate. Plating density was 20,000 neurons per well. For neurite outgrowth assays, neurons were cultured for 2-3 days and then treated for 24 hours with Rolipram, HT-2175, or HT-2157, respectively.

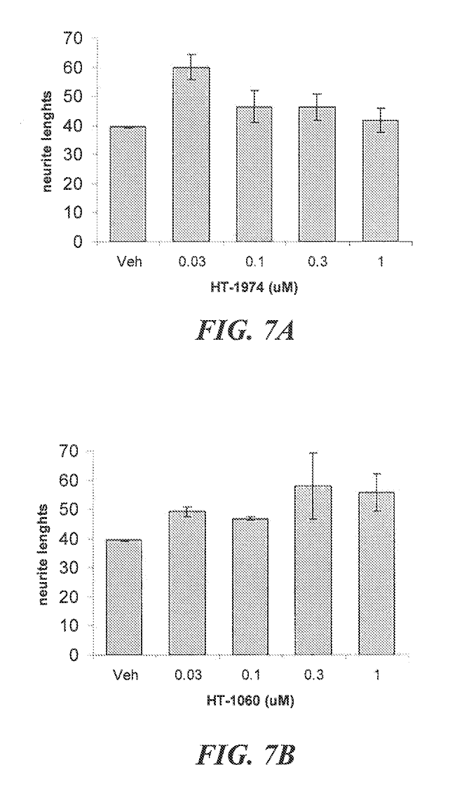

FIG. 7 A shows the quantification of the effect of inverse agonist HT-1974-specific to the α5 subunit of the GABA receptor—on neurite length in NS1 cells. HT-1974 facilitates neurite outgrowth as indicated by an increase in neurite length at a concentration of 0.03 μM HT-1974. FIG. 7B shows the quantification of the effect of monoamine-oxidase inhibitor HT-1060 on neurite length in NS1 cells. HT-1060 facilitates neurite outgrowth as indicated by an increase in neurite length. The mean±sem of 2 experimental replications per drug dose and vehicle (0.2% DMSO) are shown. For each experimental replication, neurite outgrowth in a minimum of 250 cells was measured.

1. A method for identifying a compound that enhances memory, comprising:
selecting a candidate compound from a library that induces neurite outgrowth and which also enhances CREB pathway function, whereby the compound which both induces neurite outgrowth and enhances CREB pathway function is identified as the compound that enhances memory.

2. The method of claim 1, wherein the step of selecting the candidate compound that induces neurite outgrowth, comprises:
a) providing to a neurite host cell with either the candidate compound or a control compound;
b) measuring cell growth in response to the candidate compound and the control compound; and
c) observing a difference in cell growth between the candidate compound and the control compound; whereby the candidate compound which effects a positive change in cell growth is identified as a compound that enhances neurite outgrowth.

3. The method of claim 2, wherein the neurite host cell is a Neuroscreen 1 cell.

4. The method of claim 2, wherein the neurite host cell is a mouse hippocampal neuron.

5. The method of claim 2, wherein the neurite host cell is a neuroblastoma Neuro2a cell.

6. The method of claim 2, wherein the host cell further comprises a CREB reporter construct.

7. The method of claim 6, wherein the candidate compound also upregulates the CREB reporter construct.

8. The method of claim 1, wherein the step of selecting the candidate compound that enhances CREB pathway function, comprises:
a) contacting host cells comprising an indicator gene operably linked to a CRE promoter with a candidate compound, thereby producing a test sample;
b) contacting the test sample with a suboptimal dose of a CREB function stimulating agent;
c) determining indicator activity in said host cells which have been contacted with said test compound and with said CREB function stimulating agent;
d) comparing the indicator activity with the indicator activity in control cells which have been contacted with said CREB function stimulating agent and which have not been contacted with said test compound; and
e) selecting said test compound If: 1) the indicator activity determined in step c) is increased relative to the indicator activity in said control cells which have been contacted with said CREB function stimulating agent and which have not been contacted with said test compound; and 2) the indicator activity in control cells which have not been contacted with said CREB function stimulating agent and which have been contacted with said test compound is not significantly different relative to the indicator activity in control cells which have not been contacted with said CREB function stimulating agent and which have not been contacted with said test compound.

9. The method of claim 8, further comprising the steps of:
repeating steps a) to e) with a range of different concentrations of said test compound selected in step e);
g) selecting said test compound If: 1) the indicator activity is increased in the range of different concentrations for said test compound relative to the indicator activity in said control cells which have been contacted with said CREB function stimulating agent and which have not been contacted with said test compound; and 2) the indicator activity in control cells to which have not been contacted with said CREB function stimulating agent and which have been introduced said range of different concentrations of said test compound is not significantly different relative to the indicator activity in control cells which have not been contacted with said CREB pathway function stimulating agent and which have not been contacted with said test compound, thereby selecting a candidate compound;
h) contacting cells of neural origin with said candidate compound selected in step g) and with a suboptimal dose of a CREB function stimulating agent;
i) assessing endogenous CREB-dependent gene expression in the cells which have been contacted with said candidate compound and with said CREB function stimulating agent;
j) comparing endogenous CREB-dependent gene expression assessed in step i) with endogenous CREB-dependent gene expression in control cells which have been contacted with said CREB function stimulating agent and which have not been contacted with said candidate compound;
k) selecting said candidate compound if:
l) endogenous CREB-dependent gene expression assessed in step i) is increased relative to endogenous CREB-dependent gene expression in control cells which have been contacted with said CREB function stimulating agent and which have not been contacted with said candidate compound; and 2) endogenous CREB-dependent gene expression in control cells which have not been contacted with said CREB function stimulating agent and which have been contacted with said candidate compound is not significantly different relative to the CREB-dependent gene expression in control cells which have not been contacted with said CREB function stimulating agent and which have not been contacted with said candidate compound, thereby selecting a confirmed candidate compound; l) administering said confirmed candidate compound selected in step k) to an animal;
m) training said animal administered said confirmed candidate compound under conditions appropriate to produce long term memory formation in said animal;
n) assessing long term memory formation in said animal trained in step m); and
o) comparing long term memory formation assessed in step n) with long term memory formation produced in the control animal to which said confirmed candidate compound has not been administered.

10. The method of claim 9, wherein said host cells are human neuroblastoma cells and said cells of neural origin are neurons.

11. The method of claim 10, wherein said neurons are primary hippocampal cells.

12. The method of claim 9, wherein said indicator gene encodes luciferase.

13. The method of claim 9, wherein said CREB function stimulating agent is forskolin.

14. The method of claim 13, wherein steps a) to e) are repeated with a range of four different concentrations of said test compound selected in step e).

15. The method of claim 9, wherein said animal is a mammal.


SEQUENCE LISTING (4 sequences)

SEQ ID NO: 1 - RNA, 21 nt, Artificial Sequence
  Description of Artificial Sequence Synthetic oligonucleotide
gaggcacgcccaucagauauu

SEQ ID NO: 2 - RNA, 21 nt, Artificial Sequence
  Description of Artificial Sequence Synthetic oligonucleotide
uaucugaugggcgugccucuu

SEQ ID NO: 3 - RNA, 21 nt, Artificial Sequence
  Description of Artificial Sequence Synthetic oligonucleotide
uagcgacuaaacacaucaauu

SEQ ID NO: 4 - RNA, 21 nt, Artificial Sequence
  Description of Artificial Sequence Synthetic oligonucleotide
uugauguguuuagucgcuauu